(19) United States
(12) Patent Application Publication
(10) Pub. No.: US 2022/0357266 A1
(43) Pub. Date: Nov. 10, 2022

(54) MICROCHIP FOR BIOPARTICLE ANALYSIS, BIOPARTICLE ANALYZER, MICROCHIP FOR MICROPARTICLE ANALYSIS, AND MICROPARTICLE ANALYZER

(71) Applicant: Sony Group Corporation, Tokyo (JP)

(72) Inventors: Junji Kajihara, Tokyo (JP); Kazuya Takahashi, Kanagawa (JP)

(73) Assignee: Sony Group Corporation, Tokyo (JP)

(21) Appl. No.: 17/762,881

(22) PCT Filed: Aug. 6, 2020
(86) PCT No.: PCT/JP2020/030113

§ 371 Date: Mar. 23, 2022

(30) Foreign Application Priority Data
Sep. 30, 2019 (JP) 2019-180263

(51) Int. Cl. G01N 15/14; G02B 19/00

(52) U.S. Cl. CPC G01N 15/1436; G01N 15/1459; G02B 19/0014; G01N 2015/1006

(57) ABSTRACT

Techniques for analyzing bioparticles are described. The techniques may involve a microchip for bioparticle analysis. The microchip may include at least one channel configured to provide a flow path for one or more biological particles and at least one optic configured to receive fluorescence generated by irradiating at least some of the one or more biological particles in the flow path with at least one light beam. The at least one optic may have a surface configured to direct the fluorescence. A first portion of the surface may be configured to receive the at least one light beam. The first portion may have a different curvature that at least one second portion of the surface.

### CROSS REFERENCE TO RELATED APPLICATIONS

This application claims priority to Japanese Priority Patent Application JP 2019-180263 filed on Sep. 30, 2019, the entire contents of which is incorporated herein by reference.

### TECHNICAL FIELD

The present technology relates to a microchip for bioparticle analysis and a bioparticle analyzer. More specifically, the present technology relates to a microchip for bioparticle analysis and a bioparticle analyzer used to analyze a biological particle on the basis of a fluorescence generated by irradiation of a laser light beam on the biological particle. Furthermore, the present technology relates to a microchip for microparticle analysis and a microparticle analyzer used for the similar analysis.

### BACKGROUND ART

Analysis using detection of light is performed in various technical fields. For example, a flow cytometer detects a fluorescence or scattered light generated by light irradiation on a cell, and then, characteristics of the cell is analyzed on the basis of the detection result. Furthermore, in a microfluidic device technical field, analysis based on the light detection is performed. For example, light is detected to monitor a chemical or biochemical reaction. For example, PTL 1 below discloses a microfluidic device used to detect light. The microfluidic device includes a main body structure, at least two microscale channels that are disposed in the main body structure and intersect with each other and a light change optical element that is integrated with the main body structure adjacent to one of the at least two intersecting microscale channels.

### CITATION LIST

### Patent Literature

[PTL 1] U.S. Pat. No. 6,100,541

### SUMMARY

### Technical Problem

To analyze a biological particle that flows in a flow path in a microchip, there is a case where a fluorescence generated by light irradiation on the biological particle is detected. In such analysis, the fluorescence is often weak, and it is requested to detect the fluorescence with higher efficiency.

In such analysis, there is a case where the microchip is exchanged to prevent contamination. There is a case where the exchange slightly shifts a position of an optical irradiation system with respect to the microchip. Therefore, it is desirable that such a positional gap be allowed for a biological particle analysis system in which the microchip is exchanged.

Furthermore, in such analysis, there is a case where two or more different positions on the single biological particle are irradiated with light. In this case, it is desirable that the positional gap be allowed regarding all the irradiation positions of the light irradiated on the two or more positions.

It is desirable to solve at least one of the problems described above. For example, it is desirable to provide a microchip that enables to more efficiently detect a fluorescence generated by light irradiation on the biological particle. Furthermore, it is desirable to provide a microchip that enables to efficiently detect the fluorescence and allows a positional gap of an irradiation position of light.

### Solution to Problem

The present inventors have found that the above problems can be solved by a microchip having a specific configuration.

According to the present application, some embodiments are directed to a microchip for bioparticle analysis comprising: at least one channel configured to provide a flow path for one or more biological particles; and at least one optic configured to receive fluorescence generated by irradiating at least some of the one or more biological particles in the flow path with at least one light beam. The at least one optic has a surface configured to direct the fluorescence. A first portion of the surface is configured to receive the at least one light beam, the first portion having a different curvature than at least one second portion of the surface.

In some embodiments, the first portion of the surface has a smaller curvature than the at least one second portion of the surface. In some embodiments, the first portion of the surface is substantially flat. In some embodiments, the first portion of the surface is substantially parallel to a surface of the microchip. In some embodiments, the first portion of the surface is inclined with respect to a surface of the microchip. In some embodiments, the first portion of the surface is substantially perpendicular to the at least one light beam.

In some embodiments, the at least one optic is positioned relative to the at least one channel such that the at least one optic is configured to direct at least a portion of the at least one light beam to the flow path. In some embodiments, the at least one light beam includes a plurality of light beams, and the at least one optic is positioned relative to the at least one channel such that the at least one optic is configured to direct at least a portion of the plurality of light beams to the flow path. In some embodiments, at least two irradiation positions of the plurality of light beams are aligned along a flow direction of the flow path.

In some embodiments, the first portion is positioned to receive a plurality of light beams. In some embodiments, the at least one optic includes a plurality of optics, each having a substantially flat portion of a surface, and the microchip is positioned such that the substantially flat portion of the surface for one or more of the plurality of optics is configured to receive at least some of the at least one light beam. In some embodiments, the surface is at least partially curved. In some embodiments, at least a part of the surface has a convex shape. In some embodiments, the surface has a curvature that directs the fluorescence towards an optical axis of the at least one optic. In some embodiments, the first portion is at a location corresponding to a peak in curvature of the convex shape. In some embodiments, the surface has a second portion having a convex shape, the second portion surrounding the first portion.

In some embodiments, the first portion has an area equal to or greater than a cross-sectional area of the at least one light beam. In some embodiments, the at least one optic is integrated with the microchip.

According to the present application, some embodiments are directed to a bioparticle analyzer comprising: a microchip for bioparticle analysis; at least one light source configured to generate the at least one light beam; and at least one detector configured to detect the fluorescence. The microchip includes at least one channel configured to provide a flow path for one or more biological particles and at least one optic configured to receive fluorescence generated by irradiating at least some of the one or more biological particles in the flow path with at least one light beam. The at least one optic has a surface configured to direct the fluorescence. A first portion of the surface is configured to receive the at least one light beam, the first portion having a different curvature than at least one second portion of the surface.

In some embodiments, the bioparticle analyzer comprises an apparatus having the at least one light source and the at least one detector. The microchip is configured to detachably couple to the apparatus.

In some embodiments, the first portion of the surface is substantially parallel to a surface of the microchip. In some embodiments, the surface has a curvature that directs the fluorescence towards an optical axis of the at least one optic. In some embodiments, the bioparticle analyzer is configured to perform flow cytometry and obtain measurements corresponding to the one or more biological particles.

According to the present application, some embodiments are directed to a microchip for microparticle analysis comprising: at least one channel configured to provide a flow path for one or more microparticles; and at least one optic configured to receive fluorescence generated by irradiating at least some of the one or more microparticles in the flow path with at least one light beam. The at least one optic has a surface configured to direct the fluorescence. A first portion of the surface is configured to receive the at least one light beam, the first portion having a different curvature than at least one second portion of the surface.

According to the present application, some embodiments are directed to a microparticle analyzer comprising: a microchip for microparticle analysis; at least one light source configured to generate the at least one light beam; and at least one detector configured to detect the fluorescence.

The microchip includes at least one channel configured to provide a flow path for one or more microparticles; and at least one optic configured to receive fluorescence generated by irradiating at least some of the one or more microparticles in the flow path with at least one light beam. The at least one optic has a surface configured to direct the fluorescence. A first portion of the surface is configured to receive the at least one light beam, the first portion having a different curvature than at least one second portion of the surface.

### BRIEF DESCRIPTION OF DRAWINGS

FIG. 1 is a schematic diagram of an example of a portion of biological particles, flowing in a microchip for bioparticle analysis according to an embodiment of the present technology, irradiated with a laser light beam.

FIG. 2 is a schematic diagram of an example of a portion of the biological particles, flowing in the microchip for bioparticle analysis according to an embodiment of the present technology, irradiated with the laser light beam.

FIG. 3 is a schematic diagram of an example of a portion of the biological particles, flowing in the microchip for bioparticle analysis according to an embodiment of the present technology, irradiated with the laser light beam.

FIG. 4 is a schematic diagram of an example of a portion of the biological particles, flowing in the microchip for bioparticle analysis according to an embodiment of the present technology, irradiated with the laser light beam.

FIG. 5 is a schematic diagram illustrating an exemplary configuration of the microchip for bioparticle analysis according to an embodiment of the present technology.

FIG. 6 is a schematic diagram illustrating an exemplary configuration of the microchip for bioparticle analysis according to an embodiment of the present technology.

FIGS. 7A to 7C are enlarged views of a particle sorting portion of the exemplary configuration of the microchip for bioparticle analysis according to an embodiment of the present technology.

FIG. 8 is a block diagram of an example of a control unit.

FIG. 9 is a diagram illustrating an exemplary configuration of an optical system.

FIG. 10 is a diagram for explaining a relationship between the microchip for bioparticle analysis and an objective lens.

FIG. 11 is a diagram for explaining the relationship between the microchip for bioparticle analysis and the objective lens.

FIG. 12 is a diagram for explaining a shape of a flat surface.

### DESCRIPTION OF EMBODIMENTS

Preferred embodiments for carrying out the present technology will be described below. Note that embodiments to be described below indicate representative embodiments of the present technology, and the scope of the present technology is not limited to only these embodiments. Note that description of the present technology will be made in the following order.

1. First Embodiment (Microchip for Bioparticle Analysis)

(1) Description of First Embodiment

(1-1) Microchip for Bioparticle Analysis Including Fluorescence Condensing Portion

(1-2) Example in Which Fluorescence Condensing Portion Has Flat Surface

(1-3) Example in Which Plurality of Laser Light Beams Enters Flat Surface

(1-4) Microchip for Bioparticle Analysis Including Plurality of Fluorescence Condensing Portions

(1-5) Shape of Fluorescence Condensing Portion

(2) Example of Microchip for Bioparticle Analysis

(2-1) Exemplary Configuration of Microchip for Bioparticle Analysis

(2-2) Exemplary Configuration of Optical System

2. Second Embodiment (Bioparticle Analyzer)

3. Third Embodiment (Microchip for Microparticle Analysis)

4. Fourth Embodiment (Microparticle Analyzer)

### 1. First Embodiment (Microchip for Bioparticle Analysis)

(1) Description of First Embodiment

(1-1) Microchip for Bioparticle Analysis Including Fluorescence Condensing Portion

A microchip for bioparticle analysis according to an embodiment of the present technology includes a flow path in which biological particle flows and at least one fluorescence condensing portion through which at least one fluorescence generated by irradiation of at least one laser light beam on the biological particle in the flow path passes and that collects the fluorescence. The fluorescence condensing portion collects the fluorescence generated by the laser light beam irradiation on the biological particle so as to detect the fluorescence with higher efficiency. According to some embodiments, a fluorescence condensing portion as described herein may be one or more optics (e.g., a lens). A microchip as described herein may be used as a flow cytometer chip, according to some embodiments.

According to some embodiments, the flow path may be used for collecting microparticles where the flow path is part of a microparticle analyzer (e.g., a flow cytometer) for analyzing and/or collecting microparticles by forming droplets. In some embodiments, the flow path may be in a structure (e.g., a flow cell or microchip). In some embodiments, the flow path may be part of a microparticle analyzer that analyzes and/or sorts microparticles without forming droplets. In some embodiments, the flow path may be a flow path in a chip. It should be appreciated that aspects of the present application as described herein are not limited to a particular type of device or system and that these are provided as examples. The position adjustment techniques described herein may be implemented in various devices for analyzing and/or sorting microparticles.

In the present technology, the microchip for bioparticle analysis may be configured so that the at least one laser light beam passes through the at least one fluorescence condensing portion and reaches the biological particle in the flow path. For example, the microchip for bioparticle analysis may be configured so that a single laser light beam passes through a single fluorescence condensing portion and reaches the biological particle in the flow path or the microchip for bioparticle analysis may be configured so that the plurality of laser light beams passes through the at least one fluorescence condensing portion and reaches the biological particle in the flow path. In this way, in the present technology, both of the laser light beam and the fluorescence may pass through the fluorescence condensing portion.

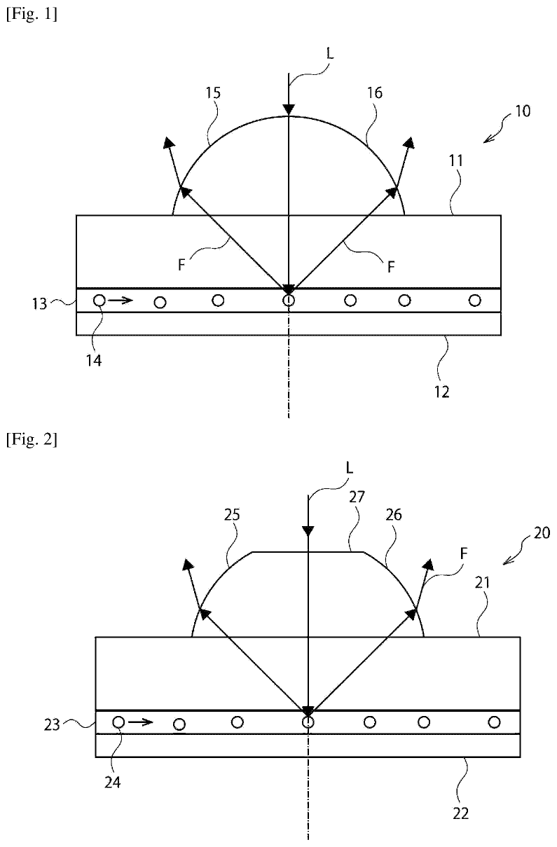

An example of the microchip for bioparticle analysis according to an embodiment of the present technology will be described with reference to FIG. 1. FIG. 1 is a schematic diagram of a portion of biological particles flowing in the microchip irradiated with a laser light beam. A microchip for bioparticle analysis 10 illustrated in FIG. 1 is a thin plate-shaped chip including two surfaces 11 and 12. A flow path 13 is provided in the microchip 10, and a biological particle 14 flows in the flow path 13. The microchip 10 includes a fluorescence condensing portion 15 provided on the surface 11. The fluorescence condensing portion 15 has, for example, a convex shape, and more particularly, may have a spherical lens shape or an aspheric lens shape. The biological particle 14 flowing in the flow path 13 is irradiated with a laser light beam L, and the irradiation generates a fluorescence F.

Hereinafter, how the laser light beam L and the fluorescence F travel will be described in detail.

The laser light beam L is irradiated so as to travel from a space on the side of the surface 11 toward the biological particle 14. The laser light beam L enters the fluorescence condensing portion 15, passes through the fluorescence condensing portion 15 (preferably travels straight), enters the flow path 13, and then, reaches the biological particle 14 flowing in the flow path 13. Preferably, the fluorescence condensing portion 15 is disposed so that a traveling direction of the laser light beam L (particularly, traveling direction of optical axis portion of laser light beam L) does not change when the laser light beam L enters the fluorescence condensing portion 15. For example, in a case where the fluorescence condensing portion 15 has a spherical lens shape, the fluorescence condensing portion 15 is disposed so that the fluorescence condensing portion 15 does not refract the laser light beam L. For example, the fluorescence condensing portion 15 is disposed on the surface 11 of the microchip 10 so that the laser light beam L passes through the substantially center of the fluorescence condensing portion 15 having a spherical lens shape (or laser light beam L (particularly, optical axis portion thereof) enters top of lens shape at incident angle of about zero degree). The irradiation of the laser light beam L on the biological particle 14 generates the fluorescence F.

For example, the fluorescence F radially travels from the biological particle 14 toward the space on the side of the surface 11. Note that, in FIG. 1, the fluorescence F is illustrated by two arrows. However, the fluorescence F may radially travel from the biological particle 14 toward a fluorescence emission surface 16. The fluorescence F exits from the fluorescence emission surface 16 of the fluorescence condensing portion 15 to the outside of the microchip 10. The fluorescence emission surface 16 includes a surface where the incident angle of the fluorescence F to the fluorescence emission surface 16 exceeds zero degree and may be, for example, a curved surface as illustrated in FIG. 1. With this shape, the traveling direction of the fluorescence F is changed on the fluorescence emission surface 16. Preferably, the traveling direction of the fluorescence F is changed on the fluorescence emission surface 16 so that an angle formed by the traveling direction of the fluorescence F and the optical axis of the laser light beam L decreases. With this structure, the fluorescence condensing portion 15 collects the fluorescence F, and it is possible to more efficiently detect the fluorescence F.

The fluorescence F that has exited the fluorescence emission surface 16 is collected by, for example, an objective lens, and then, the collected fluorescence F is detected by a fluorescence detector. According to the types of the objective lens and the fluorescence detector, optical components may be appropriately disposed on an optical path between the two elements. For example, a mirror, a lens, an optical filter, and the like can be exemplified as the optical components. However, the optical component is not limited to these. Since the fluorescence F is collected by the fluorescence condensing portion 15 as described above, a target fluorescence detection sensitivity can be achieved by an objective lens having a lower numerical aperture (NA). Furthermore, the lower the NA of the objective lens, the smaller the objective lens can be. Therefore, it is possible to secure a wider space around the objective lens. Furthermore, the price of the objective lens tends to be lower as the NA of the objective lens is lower. Therefore, it is possible to reduce cost.

Furthermore, in a case where the NA of the objective lens is low, it is possible to further reduce the number of lenses included in the objective lens. With this structure, autofluorescence (AutoFluorescence) derived from a glass material of the lens can be reduced.

(1-2) Example in Which Fluorescence Condensing Portion Has Flat Surface

In a particularly preferred example of the present technology, the microchip for bioparticle analysis according to the present technology is configured so that the fluorescence emission surface of the at least one fluorescence condensing portion has a flat surface and the at least one laser light beam enters the flat surface. According to some embodiments, the flat surface may be substantially flat where variation in the surface is within +/−0.5%, +/−1%, +/−2%, or +/−5%. By providing the flat surface on the fluorescence emission surface, it is possible to expand a positional gap margin of the laser light beam, that is, it is possible to expand an allowable range of the positional gap of the laser light beam. Therefore, by the microchip for bioparticle analysis according to the example, it is possible to detect the fluorescence with high efficiency, and it is possible to expand the allowable range of the positional gap of the laser light beam.

An example of the microchip for bioparticle analysis according to the example will be described with reference to FIG. 2. FIG. 2 is a schematic diagram of a portion of the biological particles flowing in the microchip irradiated with the laser light beam. A microchip for bioparticle analysis 20 illustrated in FIG. 2 is the same as the microchip for bioparticle analysis 10 illustrated in FIG. 1 other than that a flat surface 27 is provided on a fluorescence emission surface 26 of a fluorescence condensing portion 25. For example, the fluorescence condensing portion 25 may have a spherical lens shape having a flat surface on a top as illustrated in FIG. 2. Alternatively, the fluorescence condensing portion 25 may have an aspheric lens shape having a flat surface on a top or may have a truncated cone shape having a flat base portion.

The flat surface 27 may be parallel to one surface of the microchip 20. For example, the flat surface 27 may be parallel to a surface 21 or 22 of the microchip 20 and may be parallel to both of the surfaces 21 and 22. According to some embodiments, the flat surface may be substantially parallel to a surface of microchip 20 where the flat surface is parallel to the surface of microchip 20 within +/−0.5%, +/−1%, +/−2%, or +/−5%. The flat surface 27 may be perpendicular to the optical axis of the laser light beam L that enters the microchip 20. With this structure, since the laser light beam L travels into the fluorescence condensing portion 25 without being refracted, an irradiation position of the laser light beam L is easily adjusted.

Effects caused by the flat surface 27 will be described below. For example, regarding the microchip 10 illustrated in FIG. 1, in a case where the incident position of the laser light beam L to the fluorescence condensing portion 15 is deviated from the top of the fluorescence condensing portion 15, a curved surface may refract the laser light beam L. There is a case where a desired position in the flow path is not irradiated with the laser light beam L due to the refraction by the curved surface. Furthermore, it is often difficult to adjust the irradiation position of the laser light beam refracted by the curved surface.

On the other hand, in the microchip 20 illustrated in FIG. 2, the flat surface 27 is provided on the fluorescence emission surface 26 of the fluorescence condensing portion 25, and the laser light beam L enters the flat surface 27. In a case where the laser light beam L perpendicularly enters the flat surface 27, the flat surface 27 does not refract the laser light beam L. In a case where the flat surface 27 is included, a range where the laser light beam L can enter a flow path 23 without being refracted can be widened than a case where the flat surface 27 is not included. The positional gap of the microchip 20 with respect to the irradiation position of the laser light beam L is allowed. Furthermore, even if the laser light beam L is slightly refracted by entering the flat surface 27 at a certain incident angle, the adjustment of the irradiation position of the laser light beam L is easier than a case where the laser light beam L enters the curved surface.

In the present embodiment, it is not necessary for the flat surface 27 to be parallel to the surface 21, that is, may be inclined with respect to the surface 21. As a result, the reflected light of the irradiated laser light beam by the flat surface 27 is directed away from the optical axis of the objective lens.

According to some embodiments, flat surface 27 may be inclined with respect to surface 21 at an angle less than 10 degrees. In some embodiments, flat surface 27 may be inclined with respect to surface 21 at an angle in the range of 3 degrees to 10 degrees, or any other angle or range of angles within that range.

(1-3) Example in Which Plurality of Laser Light Beams Enters Flat Surface

According a particularly preferred example of the present technology, the number of the fluorescence condensing portions included in the microchip for bioparticle analysis is one, the fluorescence condensing portion has a flat surface on the fluorescence emission surface, and the microchip for bioparticle analysis may be disposed so that a plurality of laser light beams enters the flat surface. That is, the number of laser light beams entering the flat surface may be equal to or more than two. The fluorescence condensing portion includes the flat surface so that a gap between the irradiation positions of the two or more laser light beams is allowed even if the number of laser light beams is equal to or more than two. By the microchip for bioparticle analysis according to this example, it is possible to detect the fluorescence with high efficiency, and it is possible to expand the allowable range of the positional gap of the two or more laser light beams.

For example, regarding the microchip 10 illustrated in FIG. 1, a case is assumed where two or more laser light beams respectively enter different positions of the fluorescence condensing portion 15. In this case, even if one laser light beam perpendicularly enters the top of the fluorescence condensing portion 15, the other laser light beam enters a position different from the top. In this case, even if the one laser light beam travels straight and enters the fluorescence condensing portion 15, the other laser light beam travels into the fluorescence condensing portion 15 as being refracted. Therefore, it is difficult to adjust the irradiation positions of the two laser light beams.

On the other hand, since the fluorescence condensing portion 15 includes the flat surface, even if the two or more laser light beams enter different positions of the fluorescence condensing portion 15, the adjustment of the irradiation positions of the two or more laser light beams becomes easier. Moreover, the two or more laser light beams enter the flat surface so that the positional gap between the irradiation positions of the laser light beams is allowed.

An example in which the number of laser light beams entering the flat surface is equal to or more than two will be described with reference to FIG. 3. FIG. 3 is the same as FIG. 2 except that three laser light beams respectively enter different positions of the flat surface 27 of the microchip 20. As illustrated in FIG. 3, each of laser light beams L1, L2, and L3 enters the flat surface 27. Optical axes of the laser light beams L1, L2, and L3 are preferably parallel. In this way, in the example, it is preferable that the two or more laser light beams be parallel to each other. With this structure, it is possible to easily adjust the irradiation position of the laser light beam to a desired position.

In a case where the biological particle passes through the irradiation position of the laser light beam L1, a fluorescence F1 is generated, and next, in a case where the biological particle passes through the irradiation position of the laser light beam L2, the fluorescence is generated. Then, in a case where the biological particle passes through the irradiation position of the laser light beam L3, the fluorescence is generated.

In the present technology, in this way, the microchip for bioparticle analysis may be configured so that the plurality of laser light beams passes through the single fluorescence condensing portion and reaches the biological particle in the flow path.

The biological particle may be irradiated with the plurality of laser light beams at different positions of the flow path 23. For example, the biological particle is irradiated with two laser light beams at different positions of the flow path 23, two fluorescences are detected at different times. A flow rate of the biological particle can be obtained from a difference between the detection times and a distance between the two irradiation positions.

In the present technology, in this way, at least two irradiation positions of the plurality of laser light beams may be aligned along the direction in which the biological particle flows.

(1-4) Microchip for Bioparticle Analysis Including Plurality of Fluorescence Condensing Portions

According to another preferred example of the present technology, the number of the fluorescence condensing portions included in the microchip for bioparticle analysis is plural, each of the plurality of fluorescence condensing portions includes a flat surface on each fluorescence emission surface, and the microchip for bioparticle analysis may be disposed so that a single laser light beam enters the flat surface of each fluorescence condensing portion. Since each fluorescence condensing portion includes the flat surface in this example, a positional gap of the irradiation position of the laser light beam is allowed.

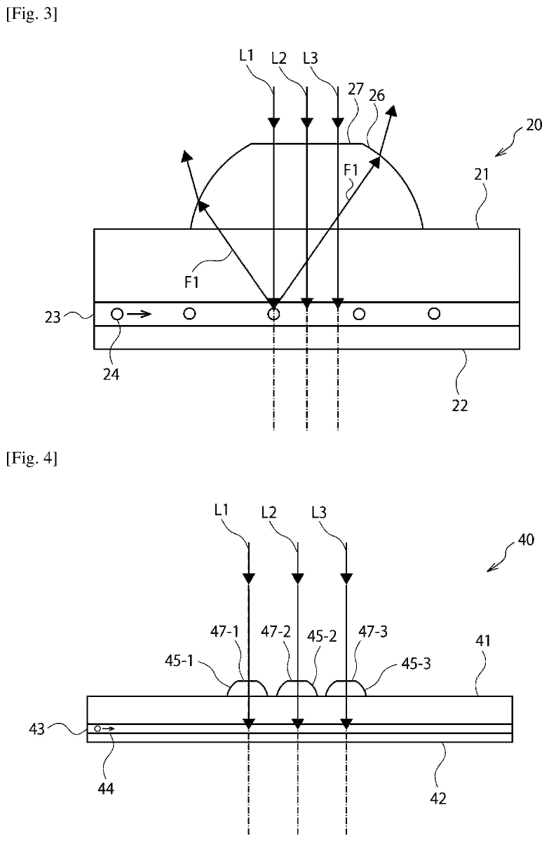

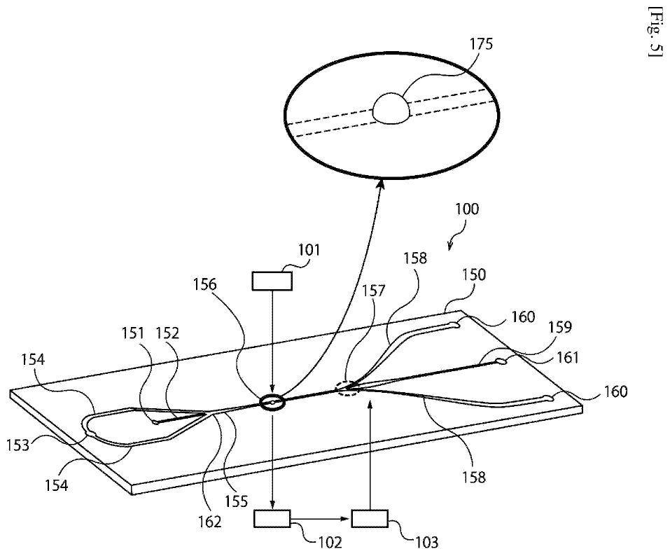

An example of the microchip for bioparticle analysis according to the example will be described with reference to FIG. 4. FIG. 4 is a schematic diagram of a portion of the biological particles flowing in the microchip irradiated with the laser light beam. A microchip for bioparticle analysis 40 illustrated in FIG. 4 includes three fluorescence condensing portions 45-1, 45-2, and 45-3. On fluorescence emission surfaces 46-1, 46-2, and 46-3 of the fluorescence condensing portions, flat surfaces 47-1, 47-2, and 47-3 are respectively provided. For example, each of the three fluorescence condensing portions may have a spherical lens shape or an aspheric lens shape having a flat surface on a top or may have a truncated cone shape having a flat base portion.

The flat surfaces 47-1, 47-2, and 47-3 may be, for example, parallel to surfaces 41 or 42 of the microchip 40. Moreover, the flat surfaces 47-1, 47-2, and 47-3 may be perpendicular to the optical axis of the laser light beam L that enters the microchip 40.

In the present technology, in this way, the microchip for bioparticle analysis may be configured so that the plurality of laser light beams respectively passes through the plurality of fluorescence condensing portions and reaches the biological particle in the flow path.

(1-5) Shape of Fluorescence Condensing Portion

(Convex Surface)

According to one example of the present technology, the fluorescence emission surface of the at least one fluorescence condensing portion is a convex surface, and more preferably, at least a part of the convex surface is a convex-lens-shaped curved surface. The convex-lens-shaped curved surface more preferably has a curvature that makes the at least one fluorescence be refracted to the side of the optical axis of the at least one laser light beam. For example, the curvature of the curved surface may be a curvature that makes the fluorescence be refracted toward an aplanatic surface or the side of the optical axis of the aplanatic surface. Here, the aplanatic surface indicates a surface drawn by a direction of the fluorescence that travels straight without being refracted when the fluorescence passes through the fluorescence emission surface. The fluorescence emission surface having such a shape is preferable from the viewpoint of efficient fluorescence collection.

(Flat Surface)

As described in (1-2) to (1-4) above, the flat surface may be provided on the fluorescence condensing portion. The flat surface is preferably provided on the top of the convex surface. More preferably, the flat surface is surrounded by the convex-lens-shaped curved surface. For example, as the flat surface 27 described in “(1-2) Example in Which Fluorescence Condensing Portion Has Flat Surface”, the flat surface may be surrounded by the convex-lens-shaped curved surface that collects the fluorescence.

According to some embodiments, the flat surface of the fluorescence condensing portion may have a different curvature than one or more other surfaces of the fluorescence condensing portion. In some embodiments, the flat surface may have a smaller curvature than the one or more other surfaces of the fluorescence condensing portion. For example, the flat surface may have little or no curvature in comparison to a convex-lens-shaped curved surface of the fluorescence condensing portion. It should be appreciated that, in some embodiments, the flat surface and the convex-lens-shaped curved surface may be considered as a single surface of the fluorescence condensing portion where the surface has a portion corresponding to the flat surface and one or more portions corresponding to the convex-lens-shaped curved surface.

An area of the flat surface may be preferably equal to or larger than an area of a spot region of a laser light beam that enters the flat surface on the flat surface. As a result, the laser light beam can travel into the fluorescence condensing portion without being refracted.

Preferably, the flat surface has a shape that covers the entire spot region of the laser light beam at the position where the laser light beam enters the fluorescence condensing portion. The shape of the flat surface may be, for example, a circle, an ellipse, or a rectangle. However, the shape of the flat surface is not limited to these.

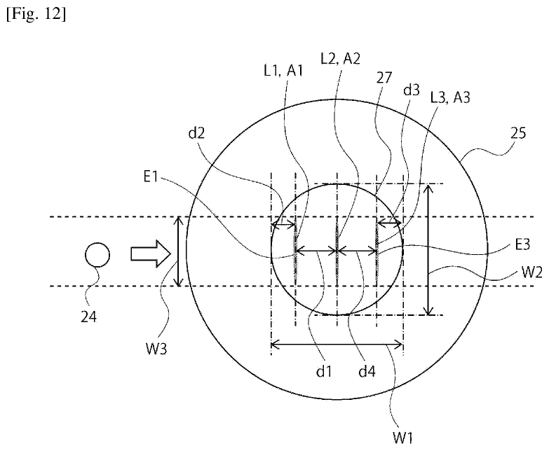

Preferably, a width W1 of the flat surface in a direction parallel to a biological particle flowing direction has a size that covers at least an upstream end and a downstream end of the spot region of the laser light beam on the flat surface. For example, regarding the configuration described with reference to FIG. 3, an irradiation spot of the laser light beam on the flat surface may be regions A1, A2, and A3 illustrated in FIG. 12. In FIG. 12, a biological particle 24 flows in an arrow direction in a flow path indicated by a dotted line, that is, the left side of the flow path is upstream, and the right side of the flow path is downstream. In FIG. 12, “the upstream end of the spot region” is a left end E1 of the spot region A1 of the laser light beam L1, and “the downstream end of the spot region” is a right end E3 of the spot region A3 of the laser light beam L3. In FIG. 12, the width W1 of the flat surface in the biological particle flowing direction has a size that covers a region from the left end (upstream end of spot region) E1 to the right end (downstream end of spot region) E3. In this way, in a case of the configuration in which the plurality of laser light beams enters the flat surface, “the upstream end of the spot region” indicates an upstream end of the laser light beam spot region positioned on the most upstream side, and “the downstream end of the spot region” indicates a downstream end of the laser light beam spot region positioned on the most downstream side.

Furthermore, in a case of the configuration in which the single laser light beam enters the flat surface, “the upstream end of the spot region” indicates an upstream end of the spot region of the single laser light beam, and “the downstream end of the spot region” indicates a downstream end of the spot region of the single laser light beam. In this case, the width W1 in the direction parallel to the biological particle flowing direction of the flat surface has a size that covers a region from the upstream end to the downstream end.

More particularly, the width W1 of the flat surface in the direction parallel to the biological particle flowing direction may be determined in consideration of a truncation coefficient of the laser light beam. In a case of the example in which the plurality of laser light beams enters the flat surface, the width W1 of the flat surface in the direction parallel to the biological particle flowing direction may be set in consideration of a spot pitch in addition to the truncation coefficient. The truncation coefficient is preferably equal to or more than two.

In a case where the plurality of laser light beams enters the flat surface, a distance between “the upstream end of the flat surface” and “an optical axis position of the laser light beam irradiated on the most upstream side” is preferably equal to or more than twice of 1/e² radius of the laser light beam irradiated on the most upstream side. In this case, a distance between “the downstream end of the flat surface” and “an optical axis position of the laser light beam irradiated on the most downstream side” is preferably equal to or more than twice of 1/e² radius of the laser light beam irradiated on the most downstream side.

For example, in FIG. 12, a distance d2 between the upstream end of the flat surface 27 and the optical axis position of the laser light beam L1 irradiated on the most upstream side may be equal to or more than twice of 1/e² radius of the laser light beam L1, and/or a distance d3 between the downstream end of the flat surface 27 and the optical axis position of the laser light beam L3 irradiated on the most downstream side may be equal to or more than twice of 1/e² radius of the laser light beam L3.

Furthermore, the spot pitch is a distance between the optical axis positions of the two laser light beams that are adjacently irradiated. The spot pitch may be preferably equal to or more than a total value of “the length that is twice of 1/e² radius of one laser light beam” of the two laser light beams and “the length that is twice of 1/e² radius of the other laser light beam”.

For example, in FIG. 12, a spot pitch d1 is a distance between the optical axis position of the laser light beam L1 and the optical axis position of the laser light beam L2. The spot pitch d1 is preferably equal to or more than the total value of the length that is twice of 1/e² radius of the laser light beam L1 and the length that is twice of 1/e² radius of the laser light beam L2.

A spot pitch d4 is a distance between the optical axis position of the laser light beam L2 and the optical axis position of the laser light beam L3. The spot pitch d4 is preferably equal to or more than the total value of the length that is twice of 1/e² radius of the laser light beam L2 and the length that is twice of 1/e² radius of the laser light beam L3.

In FIG. 12, in consideration of the above, the width W1 of the flat surface in the direction parallel to the biological particle flowing direction may be preferably a total value of the spot pitches d1, d2, d3, and d4.

In a case where the single laser light beam enters the flat surface, a distance between “the upstream end of the flat surface” and “the optical axis position of the laser light beam” may be equal to or more than twice of 1/e² radius of the laser light beam and/or a distance between “the downstream end of the flat surface” and “the optical axis position of the laser light beam” may be equal to or more than twice of 1/e² radius of the laser light beam. In this case, the width W1 may be a total value of the two distances.

The width W1 in the direction parallel to the biological particle flowing direction may be determined in consideration of a temporal change in the position of the spot region of the laser light beam. For example, a laser light beam irradiation device generates heat according to the irradiation of the laser light beam, and a luminous point position of the laser light beam may change with time. By setting the width in consideration of the temporal change, it is possible to more reliably make the laser light beam enter the flat surface.

A width W2 of the flat surface in a direction perpendicular to the biological particle flowing direction may be, for example, equal to or more than a width W3 of the flow path. With this structure, the position in the perpendicular direction through which the biological particle may pass can be covered with the laser light beam that enters the flat surface.

According to another example of the present technology, the at least one fluorescence condensing portion may be a diffractive element. For example, the diffractive element may have optical characteristics for transmitting the laser light beam and diffracts the fluorescence generated by irradiating the biological particle with the laser light beam. The optical characteristics may be realized, for example, by a wavelength selectivity of the diffractive element.

(2) Example of Microchip for Bioparticle Analysis

(2-1) Exemplary Configuration of Microchip for Bioparticle Analysis

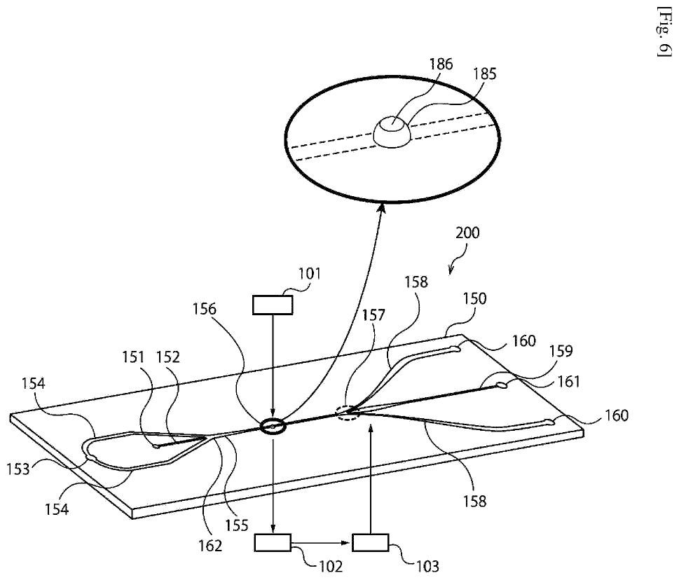

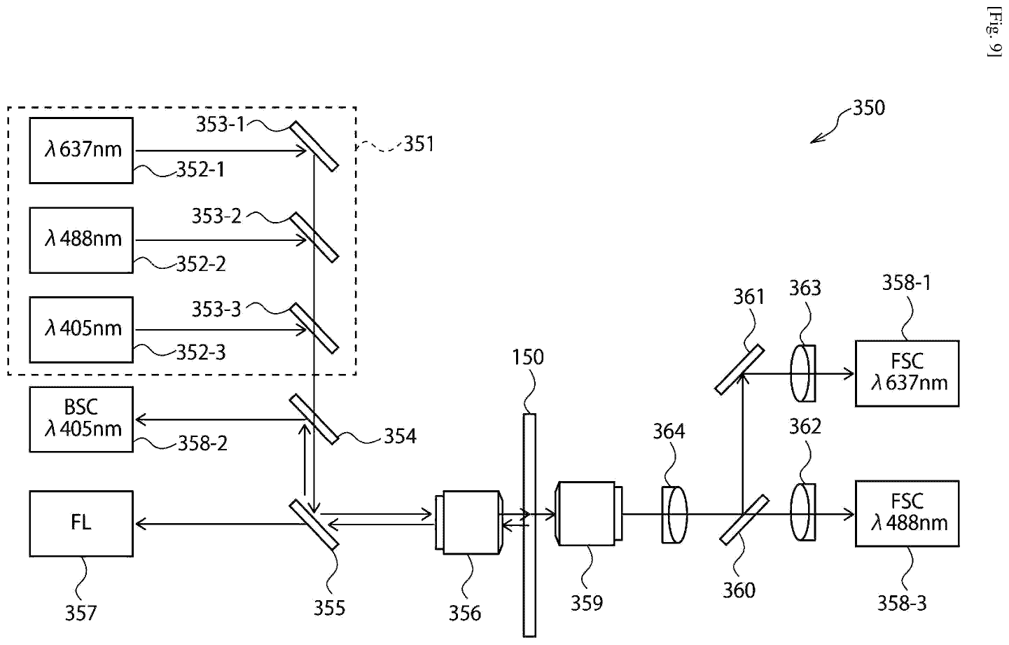

FIG. 5 is a schematic perspective diagram illustrating an exemplary configuration of the microchip for bioparticle analysis. A microchip for bioparticle analysis 150 illustrated in FIG. 5 may be used in combination with a light irradiation unit 101, a detection unit 102, and a control unit 103. An example of a block diagram of the control unit 103 is illustrated in FIG. 8. As illustrated in FIG. 8, the control unit 103 may include, for example, a signal processing unit 104, a determination unit 105, and a sorting control unit 106. The light irradiation unit 101, the detection unit 102, the control unit 103, and the microchip for bioparticle analysis 150 may be configured, for example, as a bioparticle analyzer 100.

The microchip for bioparticle analysis 150 will be described first below, and then, other components will be described in detail.

In the microchip for bioparticle analysis 150, a sample liquid inlet 151 and a sheath liquid inlet 153 are provided. Sample liquid and sheath liquid are respectively introduced from the inlets into a sample liquid flow path 152 and a sheath liquid flow path 154. The sample liquid includes biological particles.

The sample liquid and the sheath liquid are merged at a merging portion 162 and form a laminar flow in which the sample liquid is surrounded by the sheath liquid. The laminar flow flows in a main flow path 155 toward a particle sorting portion 157.

The main flow path 155 includes a detection region 156. In the detection region 156, biological particles in the sample liquid are irradiated with light. On the basis of the fluorescence and/or scattered light generated by the irradiation of the light, it may be determined whether or not the biological particle is to be collected.

In the present technology, the detection region 156 may include the single fluorescence condensing portion and the single fluorescence condensing portion may be irradiated with the single or plurality of laser light beams or the detection region 156 may include two or more fluorescence condensing portions and the two or more fluorescence condensing portions may be irradiated with the laser light beams.

In the detection region 156, the fluorescence condensing portion described in “(1) Description of First Embodiment” above is provided. An enlarged view of the detection region 156 is illustrated in an upper portion of FIG. 5. As illustrated in the enlarged view, a fluorescence condensing portion 175 is provided in the detection region 156. Regarding the fluorescence condensing portion 175, the description of the fluorescence condensing portion 15 described with reference to FIG. 1 in “(1-1) Microchip for Bioparticle Analysis Including Fluorescence Condensing Portion” can be applied.

Alternatively, as illustrated in FIG. 6, a fluorescence condensing portion 185 including a flat surface 186 may be provided in the detection region 156. Regarding the fluorescence condensing portion 185, the description of the fluorescence condensing portion 25 described with reference to FIGS. 2 and 3 in “(1-2) Example in Which Fluorescence Condensing Portion Has Flat Surface” and “(1-3) Example in Which Plurality of Laser Light Beams Enters Flat Surface” can be applied.

Moreover, alternatively, a plurality of fluorescence condensing portions may be provided in the detection region 156, preferably along the flowing direction of the flow path. The plurality of fluorescence condensing portions may be as described in “(1-4) Microchip for Bioparticle Analysis Including Plurality of Fluorescence Condensing Portions”.

In a particularly preferable example of the present technology, the microchip 150 may be configured so that a single fluorescence condensing portion including a single flat surface is provided in the detection region 156 and each of two or more different positions of the flat surface is irradiated with laser light beams.

For example, in a case where each of the two different positions of the flat surface is irradiated with the single laser light beam, for example, the biological particle is analyzed on the basis of light (for example, fluorescence and/or scattered light) generated by the light irradiation on the biological particle at one position, and moreover, it may be determined whether or not the biological particle is to be collected. Moreover, a speed of the biological particle in the flow path can be calculated on the basis of a difference between a detection time of the light generated by the light irradiation at the one position and a detection time of light generated by light irradiation at another position. A distance between the two irradiation positions may be determined in advance for the above calculation, and the speed of the biological particle may be determined on the basis of the difference between the two detection times and the distance. Moreover, it is possible to accurately predict an arrival time at the particle sorting portion 157 to be described below on the basis of the speed. By accurately predicting the arrival time, a timing when a flow into a particle sorting flow path 159 is formed can be optimized. Furthermore, in a case where a difference between an arrival time of a certain biological particle at the particle sorting portion 157 and an arrival time of a biological particle before or after the certain biological particle at the particle sorting portion 157 is equal to or less than a predetermined threshold, it is possible to determine not to sort the certain biological particle. In a case where a distance between the certain biological particle and a biological particle before or after the certain biological particle is narrow, a possibility increases that the biological particle before or after the certain biological particle is collected together when the certain biological particle is suctioned. By determining not to sort the certain biological particle in a case where the possibility that the biological particle is collected together is high, it is possible to prevent the biological particle before or after the certain biological particle from being collected. As a result, it is possible to enhance purity of a target biological particle among the collected biological particles. Specific examples of the microchip in which the two different positions in the detection region 156 are irradiated with light and the device including the microchip are described, for example, in JP 2014-202573 A.

In the particle sorting portion 157 in the microchip 150, the laminar flow that has flowed through the main flow path 155 flows separately into two branch flow paths 158. The particle sorting portion 157 illustrated in FIG. 2 includes the two branch flow paths 158. However, the number of branch flow paths is not limited to two. In the particle sorting portion 157, for example, one or a plurality of (for example, two, three, or four) branch flow paths may be provided. The branch flow path may be configured to be branched in a Y-shape on one plane as illustrated in FIG. 2 or may be configured to be three-dimensionally branched.

Furthermore, only in a case where the biological particle to be collected is flowed to the particle sorting portion 157, a flow into the particle sorting flow path 159 is formed, and the biological particle is collected. The flow into the particle sorting flow path 159 may be formed, for example, by generating a negative pressure in the particle sorting flow path 159. To generate the negative pressure, for example, an actuator 107 may be attached outside the microchip 150 so that a wall of the particle sorting flow path 159 can be deformed. The deformation of the wall changes an inner space of the particle sorting flow path 159, and the negative pressure may be generated. The actuator 107 may be, for example, a piezo actuator. When the biological particle is suctioned into the particle sorting flow path 159, the sample liquid included in the laminar flow or the sample liquid and the sheath liquid included in the laminar flow may be flowed into the particle sorting flow path 159. In this way, the biological particle is sorted by the particle sorting portion 157.

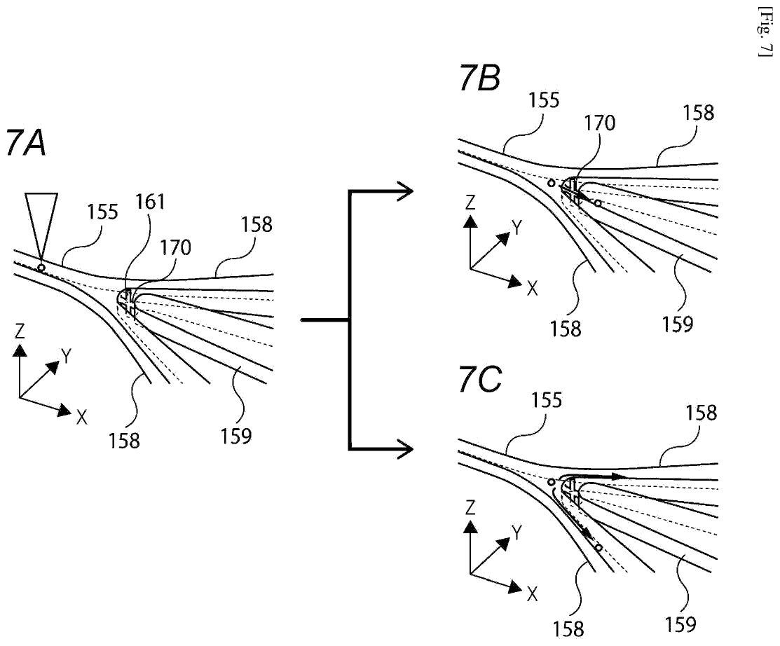

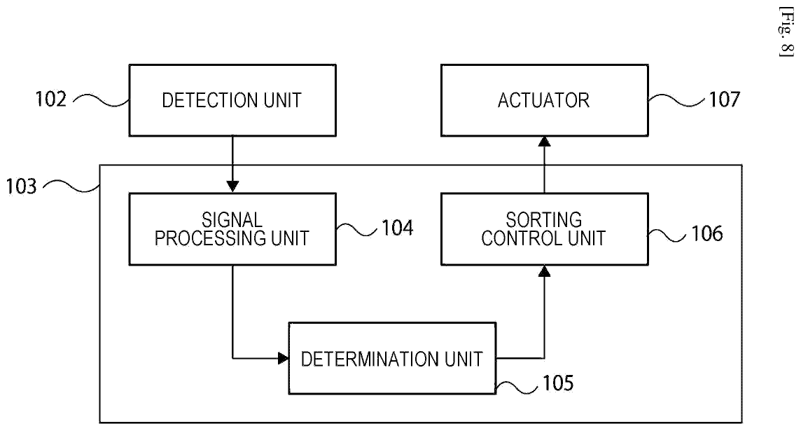

An enlarged view of the particle sorting portion 157 is illustrated in FIGS. 7A to 7C.

As illustrated in FIG. 7A, the main flow path 155 and the particle sorting flow path 159 are communicated with each other via an orifice 170 coaxially provided with the main flow path 155. As illustrated in FIG. 7B, the biological particle to be collected passes through the orifice 170 and flows into the particle sorting flow path 159. The biological particle not to be collected flows into the branch flow path 158 as illustrated in FIG. 7C.

In order to prevent the biological particle not to be collected from entering the particle sorting flow path 159 through the orifice 170, a gate flow inlet 171 may be included in the orifice 170. The sheath liquid is introduced from the gate flow inlet 171, and a part of the introduced sheath liquid forms a flow from the orifice 170 toward the main flow path 155 so as to prevent the biological particle not to be collected from entering the particle sorting flow path 159. Note that remaining sheath liquid that has been introduced flows to the particle sorting flow path 159.

The laminar flow that has flowed to the branch flow path 158 may be discharged to the outside of the microchip at a branch flow path end 160. Furthermore, the biological particle collected to the particle sorting flow path 159 may be discharged to the outside of the microchip at a particle sorting flow path end 161. In this way, the target biological particle is sorted by the microchip 150.

A container may be connected to the particle sorting flow path end 161. The biological particle sorted by the particle sorting portion 157 is collected into the container.

Furthermore, a particle collection flow path may be connected to the particle sorting flow path end 161. One end of the particle collection flow path may be connected to the particle sorting flow path end 161, and another end may be connected to a container (not illustrated) used to collect the biological particle sorted in the particle sorting flow path 159. In this way, according to one example of the present technology, the bioparticle analyzer 100 may include the particle collection flow path used to collect the biological particle sorted by the particle sorting portion 157 into the container. The sorted biological particle passes through the particle collection flow path and is collected into the container.

In the present technology, “micro” means that at least a part of the flow path included in the microchip for bioparticle analysis 150 has a μm-order dimension, particularly, a μm-order cross-sectional dimension. That is, in the present technology, “the microchip” indicates a chip including the μm-order flow path, particularly, a chip including a flow path having the μm-order cross-sectional dimension. For example, a chip including the particle sorting portion including the flow path having the μm-order cross-sectional dimension may be called as the microchip according to the present technology. In the present technology, the microchip may include, for example, the particle sorting portion 157. In the particle sorting portion 157, the cross-section of the main flow path 155 is, for example, a rectangle, and the width of the main flow path 155 is, for example, 100 μm to 500 μm in the particle sorting portion 157, particularly, may be 100 μm to 300 μm. The width of the branch flow path branched from the main flow path 155 may be narrower than the width of the main flow path 155. The cross section of the orifice 170 is, for example, a circle. A diameter of the orifice 170 at a connection portion between the orifice 170 and the main flow path 155 may be, for example, 10 μm to 60 μm, particularly, 20 μm to 50 μm. These dimensions relating to the flow path may be appropriately changed according to the size of the biological particle.

The size of the flow path of the microchip may be appropriately selected according to the size and the mass of the biological particle described above. In the present technology, a chemical or biological label, for example, a fluorescent dye may be attached to the biological particle as necessary. The label makes the detection of the biological particle easier. The label to be attached may be appropriately selected by those skilled in the art.

Fluid flowing in the microchip for bioparticle analysis 150 according to an embodiment of the present technology is, for example, liquid, a liquid material, or gas, and preferably, is liquid. The type of the fluid may be appropriately selected by those skilled in the art, for example, according to the type of the biological particle to be sorted and the like. For example, sheath liquid and sample liquid that are available in the market or sheath liquid and sample liquid known in the art may be used as the fluid.

The microchip for bioparticle analysis 150 may be manufactured by a known method in the art. For example, the microchip for bioparticle analysis 150 can be manufactured by bonding two or more substrates on which predetermined flow paths are formed. For example, the flow path may be formed on all of the two or more substrates (particularly, two substrates), or may be formed only on some of the two or more substrates (particularly, one of two substrates). In order to easily adjust the position where the substrates are bonded, the flow path is preferably formed only on the single substrate.

Furthermore, the fluorescence condensing portion 175 may be formed integrally with a substrate of the two or more substrates that forms a laser light beam incident side surface. As a method for integral molding, a method known in the art may be used.

Alternatively, as the fluorescence condensing portion 175, an on-chip microlens may be formed on the substrate of the two or more substrates that forms the laser light beam incident side surface. The on-chip microlens may be formed by a method known in the art.

As a material used to form the microchip for bioparticle analysis 150, a material known in the art may be used. For example, polycarbonate, cycloolefin polymer, polypropylene, polydimethylsiloxane (PDMS), polymethyl methacrylate (PMMA), polyethylene, polystyrene, glass, and silicon can be exemplified. However, the material is not limited to these. In particular, for example, a polymer material such as polycarbonate, cycloolefin polymer, and polypropylene is particularly preferred since the above polymer material has excellent processability and the microchip can be inexpensively manufactured by using a molding apparatus.

The microchip for bioparticle analysis 150 is preferably transparent. For example, at least a part of the microchip for bioparticle analysis 150 through which light (laser light beam and fluorescence) passes is transparent, and for example, the detection region may be transparent. The entire microchip for bioparticle analysis 150 may be transparent.

Hereinafter, other components included in the bioparticle analyzer 100, that is, the light irradiation unit 101, the detection unit 102, and the control unit 103 will be described.

The light irradiation unit 101 irradiates the biological particle that flows through the flow path in the microchip for bioparticle analysis 150 with the laser light beam. The detection unit 102 detects light generated by the irradiation of the laser light beam. According to the characteristics of the light detected by the detection unit 102, the control unit 103 controls a flow in the microchip for bioparticle analysis 150 so as to sort only the biological particle to be collected.

The light irradiation unit 101 irradiates the biological particle that flows in the flow path in the microchip for bioparticle analysis 150 with the laser light beam (for example, excitation light and the like). The light irradiation unit 101 may include a light source that emits light and an objective lens that collects excitation light with respect to the biological particle that flows in the detection region. The light source may be appropriately selected by those skilled in the art according to a purpose of analysis, and for example, may be a laser diode, an SHG laser, a solid laser, a gas laser, or a high-brightness LED or a combination of two or more of these. The light irradiation unit may include another optical element as necessary, in addition to the light source and the objective lens.

The detection unit 102 detects scattered light and/or fluorescence generated from the biological particle by the laser light beam irradiation by the light irradiation unit 101. The detection unit 102 may include a condensing lens that collects the fluorescence and/or the scattered light generated from the biological particle and a detector. As the detector, a PMT, a photodiode, a CCD, a CMOS, and the like may be used. However, the detector is not limited to these. The detection unit 102 may include another optical element as necessary, in addition to the condensing lens and the detector. The detection unit 102 may further include, for example, a spectroscopic unit. As an optical component included in the spectroscopic unit, for example, a grating, a prism, and an optical filter can be exemplified. The spectroscopic unit can detect, for example, light having a wavelength to be detected separately from light having other wavelength. The detection unit 102 may convert the detected light into an analog electric signal by photoelectric conversion. The detection unit 102 may further convert the analog electric signal into a digital electric signal by AD conversion.

The signal processing unit 104 included in the control unit 103 may process the waveform of the digital electric signal obtained by the detection unit 102 and generate information regarding characteristics of the light used for determination made by the determination unit 105. As the information regarding the characteristics of the light, the signal processing unit 104 may obtain one, two, or three of, for example, a width of the waveform, a height of the waveform, and an area of the waveform from the waveform of the digital electric signal. Furthermore, the information regarding the characteristics of the light may include, for example, a time when the light is detected.

The determination unit 105 included in the control unit 103 determines whether or not a microparticle is sorted on the basis of the light generated by the laser light beam irradiation on the microparticle that flows in the flow path. More specifically, the light generated by the laser light beam irradiation on the microparticle by the light irradiation unit 101 is detected by the detection unit 102, the waveform of the digital electric signal obtained by the detection unit 102 is processed by the control unit 103, and then, the determination unit 105 determines whether or not the microparticle is sorted on the basis of the characteristics of the light generated by the processing.

The sorting control unit 106 included in the control unit 103 controls sorting of the biological particle by the microchip for bioparticle analysis 150. More specifically, the sorting control unit 106 may control the flow of the fluid at the particle sorting portion 157 in the microchip for bioparticle analysis 150 so as to sort the biological particle that is determined to be sorted by the determination made by the determination unit 105. In order to control the flow, the sorting control unit 106 may, for example, control driving of the actuator 107 provided near the sorting unit. A timing to drive the actuator 107 may be set, for example, on the basis of the time when the light is detected.

The control unit 103 may control the irradiation of light by the light irradiation unit 101 and/or the detection of light by the detection unit 102. Furthermore, the control unit 103 may control driving of a pump to supply the fluid in the microchip for bioparticle analysis 150. The control unit 103 may include, for example, a hard disk, a CPU, and a memory that store a program and an OS that make the bioparticle analyzer analyze and/or sort the biological particle. For example, the function of the control unit 103 may be realized by a general-purpose computer. The program may be recorded in a recording medium, for example, a microSD memory card, an SD card, a flash memory, or the like. The program recorded in the recording medium is read by a drive included in the bioparticle analyzer 100, and then, the control unit 103 may make the bioparticle analyzer 100 execute analysis and/or sorting processing of the biological particle according to the read program.

(2-2) Exemplary Configuration of Optical System

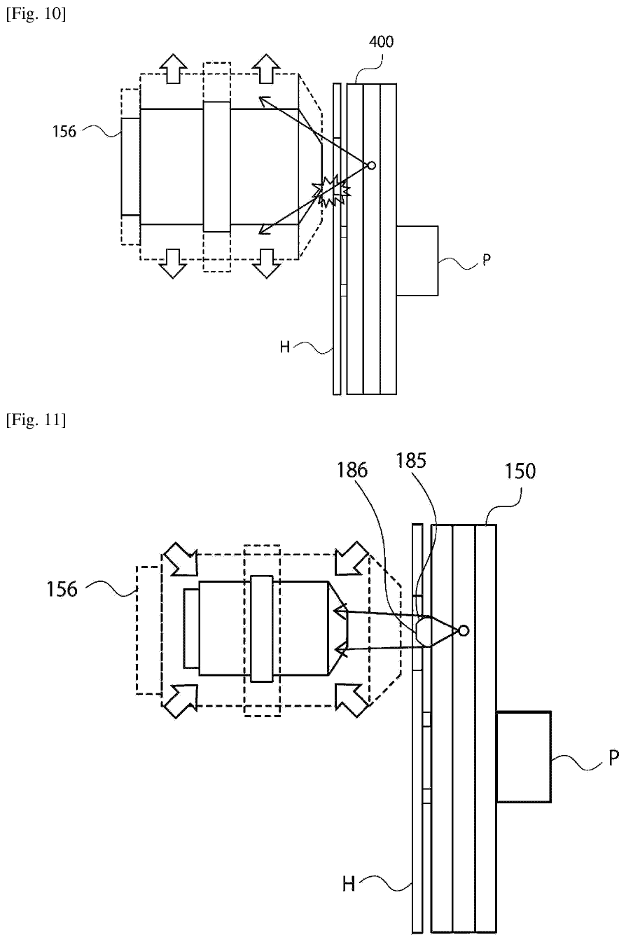

An exemplary configuration of an optical system included in the light irradiation unit 101 and the detection unit 102 described in “(2-1) Exemplary Configuration of Microchip for Bioparticle Analysis” will be described with reference to FIG. 9.

An optical system 350 illustrated in FIG. 9 includes a laser light beam generation unit 351 that generates a laser light beam irradiated on a detection region 156. The laser light beam generation unit 351 includes, for example, laser light sources 352-1, 352-2, and 352-3 and a mirror group 353-1, 353-2, and 353-3 that synthesize the laser light beams emitted from the laser light sources.

The laser light sources 352-1, 352-2, and 352-3 respectively emit laser light beams having different wavelengths.

The laser light source 352-1 emits a laser light beam having a wavelength of, for example, 550 nm to 800 nm (for example, wavelength of 637 nm). The mirror 353-1 has optical characteristics for reflecting the laser light beam.

The laser light source 352-2 emits a laser light beam having a wavelength of, for example, 450 nm to 550 nm (for example, wavelength of 488 nm). The mirror 353-2 has optical characteristics for reflecting the laser light beam and transmitting the laser light beam emitted from the laser light source 352-1.

The laser light source 352-3 emits a laser light beam having a wavelength of, for example, 380 nm to 450 nm (for example, wavelength of 405 nm). The mirror 353-3 has optical characteristics for reflecting the laser light beam and transmitting two laser light beams emitted from the laser light sources 352-1 and 352-2.

By disposing the three laser light sources and the three mirrors as illustrated in FIG. 9, the laser light beams irradiated on the biological particle are synthesized.

The laser light beam passes through a mirror 354, then, is reflected by a mirror 355, and enters an objective lens 356. The laser light beam is collected by the objective lens 356 and reaches the detection region 156 of the microchip 150.

In the present technology, the fluorescence condensing portion is provided in the detection region 156. As described above, the fluorescence condensing portion may have a flat surface on the top. The flat surface allows the positional gap of the laser light beam.

The biological particle that flows in the detection region 156 is irradiated with the laser light beam, and a fluorescence and scattered light are generated.

As described above, the laser light beam generation unit 351, the mirrors 354 and 355, and the objective lens 356 are included in the light irradiation unit 101.

The optical system 350 includes a fluorescence detector 357 that detects the fluorescence. The fluorescence enters the objective lens 356 and is collected by the objective lens 356. The fluorescence collected by the objective lens 356 passes through the mirror 355 and is detected by the fluorescence detector 357.

In the present technology, as described above, the fluorescence condensing portion is provided in the detection region of the microchip 150. With this structure, the fluorescence generated by the irradiation of the laser light beam on the biological particle is collected and enters the objective lens 356. Therefore, the fluorescence can be more efficiently detected. Furthermore, with this structure, an objective lens having a lower NA can be employed as the objective lens 356.

Advantages of the objective lens will be described below with reference to FIGS. 10 and 11. FIG. 10 is a schematic diagram illustrating a traveling direction of a fluorescence in a case where the fluorescence condensing portion is not provided, and FIG. 11 is a schematic diagram illustrating a traveling direction of the fluorescence in a case where the fluorescence condensing portion is provided.

In order to enhance a fluorescence detection sensitivity, it is considered to use an objective lens having a higher NA. However, in general, as the NA is higher, the size of the objective lens increases. As illustrated in FIG. 10, the size of the objective lens 156 increases, and a working distance (WD) decreases. Furthermore, if the size of the objective lens 156 increases, a space around the objective lens is reduced, that is, a space where the other components are disposed is reduced. Accordingly, a distance between a microchip for bioparticle analysis 400 in which a fluorescence condensing portion is not provided and the objective lens 156 is reduced, and for example, a movable range of the objective lens 156 may be limited so as not to have contact with a chip holder H that holds the microchip for bioparticle analysis 400.

Since the fluorescence can be efficiently detected according to the present technology, it is sufficient that the NA of the objective lens be low. The size of the objective lens becomes smaller as the NA is lower, and the working distance is extended. Therefore, for example, as illustrated in FIG. 11, a distance between the microchip for bioparticle analysis 150 including the fluorescence condensing portion 185 and the objective lens 156 is increased, and the working distance can be more increased. Furthermore, as the size of the objective lens 156 is reduced, the space around the objective lens 156 increases, and the space where the other components are disposed increases. Furthermore, a piezo actuator P may be attached to the microchip for bioparticle analysis 150 as the actuator 107 described above. As described above, the increase in the space around the objective lens 156 contributes to secure the space where the piezo actuator P is disposed.

The optical system 350 includes a scattered light detector 358G that detects backscattered light of the scattered light. The backscattered light enters the objective lens 356, and then, is collected by the objective lens 356. The backscattered light collected by the objective lens 356 is reflected by the mirror 355, is further reflected by the minor 354, and is detected by the scattered light detector 358G. For example, the scattered light detector 358G selectively detects green light.

The optical system 350 includes scattered light detectors 358R and 358B that detect forward-scattered light of the scattered light. The forward-scattered light enters an objective lens 359 and is separated into red light and blue light by a mirror 360. The mirror 360 may be, for example, a half minor and has optical characteristics for reflecting red light and transmitting blue light.

The red light is reflected by a minor 361, and then, is detected by the scattered light detector 358R.

The blue light is detected by the scattered light detector 358B.

For example, doublet lenses 362 to 364 may be provided on an optical path of the forward-scattered light. The doublet lenses correct an aberration of light that passes through each doublet lens.

### 2. Second Embodiment (Bioparticle Analyzer)

The present technology provides a bioparticle analyzer that includes a microchip for bioparticle analysis including a flow path in which a biological particle flows and at least one fluorescence condensing portion through which at least one fluorescence generated by irradiation of at least one laser light beam on the biological particle in the flow path passes and that collects the fluorescence. The bioparticle analyzer may further include a laser light beam irradiation device that irradiates the laser light beam toward the biological particle in the flow path and a fluorescence detection device that detects the fluorescence.

The microchip for bioparticle analysis included in the bioparticle analyzer according to an embodiment of the present technology is as described in “1. First Embodiment (Microchip for Bioparticle Analysis)”. Therefore, the bioparticle analyzer according to an embodiment of the present technology including the microchip can detect the fluorescence with higher efficiency. Moreover, an allowable range of a positional gap of a laser light beam of the bioparticle analyzer can be widened.

The laser light beam irradiation device corresponds to the light irradiation unit or the laser light beam generation unit described in “1. First Embodiment (Microchip for Bioparticle Analysis)”. Therefore, description on these can be applied to the laser light beam irradiation device.

The fluorescence detection device corresponds to the detection unit or the fluorescence detector described in “1. First Embodiment (Microchip for Bioparticle Analysis)”. Therefore, description on these can be applied to the fluorescence detection device.

According to a particularly preferred embodiment of the present technology, the microchip for bioparticle analysis can be removed from the bioparticle analyzer. With this structure, the microchip for bioparticle analysis can be exchanged, and, for example, a different microchip can be used for each sample to be analyzed. As a result, generation of contamination can be prevented.

### 3. Third Embodiment (Microchip for Microparticle Analysis)

The present technology may be used for analysis of not only a biological particle but also a synthetic particle other than the biological particle. That is, the present technology provides a microchip for microparticle analysis that includes a flow path in which a microparticle flows and at least one fluorescence condensing portion through which at least one fluorescence generated by irradiation of at least one laser light beam on the microparticle in the flow path passes and that collects the fluorescence.

Here, the microparticles include, for example, synthetic particles such as latex beads, gel beads, magnetic beads, a quantum dot, and the like, in addition to the biological particle described above.

The synthetic particle may be a particle including, for example, an organic or inorganic polymer material, metal, or the like. The organic polymer material may include polystyrene, styrene-divinylbenzene, polymethyl methacrylate, and the like. The inorganic polymer material may include glass, silica, a magnetic material, and the like. Metal may include gold colloid, aluminum, and the like.

### 4. Fourth Embodiment (Microparticle Analyzer)

Furthermore, the present technology provides a microparticle analyzer that includes a microchip for microparticle analysis including a flow path in which a microparticle flows and at least one fluorescence condensing portion through which at least one fluorescence generated by irradiation of at least one laser light beam on the microparticle in the flow path passes and that collects the fluorescence, a laser light beam irradiation device that irradiates the laser light beam toward the microparticle in the flow path, and a fluorescence detection device that detects the fluorescence. The configuration of the microparticle analyzer according to an embodiment of the present technology is similar to that of the bioparticle analyzer described above other than that an analysis target is a microparticle.

Although the embodiments described herein involve using the fluorescence condensing portion in connection with a microchip, it should be appreciated that aspects of the technology described herein is not limited to applications involving use of a microchip or flow cytometer. In some embodiments, one or more the fluorescence condensing portions described herein may be used in other applications that involve optically directing light.

It should be understood by those skilled in the art that various modifications, combinations, sub-combinations and alterations may occur depending on design requirements and other factors insofar as they are within the scope of the appended claims or the equivalents thereof.

The following configurations are within the technical scope of the present application.

[1] A microchip for bioparticle analysis including:

at least one channel configured to provide a flow path for one or more biological particles; and

at least one optic configured to receive fluorescence generated by irradiating at least some of the one or more biological particles in the flow path with at least one light beam, the at least one optic having a surface configured to direct the fluorescence, wherein a first portion of the surface is configured to receive the at least one light beam, the first portion having a different curvature than at least one second portion of the surface.

[2] The microchip for bioparticle analysis according to [1], wherein the first portion of the surface has a smaller curvature than the at least one second portion of the surface.

[3] The microchip for bioparticle analysis according to [1], wherein the first portion of the surface is substantially flat.

[4] The microchip for bioparticle analysis according to [1], wherein the first portion of the surface is substantially parallel to a surface of the microchip.

[5] The microchip for bioparticle analysis according to [1], wherein the first portion of the surface is inclined with respect to a surface of the microchip.

[6] The microchip for bioparticle analysis according to [1], wherein the first portion of the surface is substantially perpendicular to the at least one light beam.

[7] The microchip for bioparticle analysis according to [1], wherein the at least one optic is positioned relative to the at least one channel such that the at least one optic is configured to direct at least a portion of the at least one light beam to the flow path.

[8] The microchip for bioparticle analysis according to [1], wherein the at least one light beam includes a plurality of light beams, and the at least one optic is positioned relative to the at least one channel such that the at least one optic is configured to direct at least a portion of the plurality of light beams to the flow path.

[9] The microchip for bioparticle analysis according to [8], wherein at least two irradiation positions of the plurality of light beams are aligned along a flow direction of the flow path.

[10] The microchip for bioparticle analysis according to [1], wherein the first portion is positioned to receive a plurality of light beams.

[11] The microchip for bioparticle analysis according to [1], wherein the at least one optic includes a plurality of optics, each having a substantially flat portion of a surface, and the microchip is positioned such that the substantially flat portion of the surface for one or more of the plurality of optics is configured to receive at least some of the at least one light beam.

[12] The microchip for bioparticle analysis according to [1], wherein the surface is at least partially curved.

[13] The microchip for bioparticle analysis according to [12], wherein at least a part of the surface has a convex shape.

[14] The microchip for bioparticle analysis according to [13], wherein the surface has a curvature that directs the fluorescence towards an optical axis of the at least one optic.

[15] The microchip for bioparticle analysis according to [13], wherein the first portion is at a location corresponding to a peak in curvature of the convex shape.

[16] The microchip for bioparticle analysis according to [12], wherein the surface has a second portion having a convex shape, the second portion surrounding the first portion.

[17] The microchip for bioparticle analysis according to [1], wherein the first portion has an area equal to or greater than a cross-sectional area of the at least one light beam.

[18] The microchip for bioparticle analysis according to [1], wherein the at least one optic is integrated with the microchip.

[19] A bioparticle analyzer including:

a microchip for bioparticle analysis including:

at least one channel configured to provide a flow path for one or more biological particles; and

at least one optic configured to receive fluorescence generated by irradiating at least some of the one or more biological particles in the flow path with at least one light beam, the at least one optic having a surface configured to direct the fluorescence, wherein a first portion of the surface is configured to receive the at least one light beam, the first portion having a different curvature than at least one second portion of the surface;

at least one light source configured to generate the at least one light beam; and

at least one detector configured to detect the fluorescence.

[20] The bioparticle analyzer according to [19], further including an apparatus having the at least one light source and the at least one detector, and wherein the microchip is configured to detachably couple to the apparatus.

[21] The bioparticle analyzer according to [19], wherein the first portion of the surface is substantially parallel to a surface of the microchip.

[22] The bioparticle analyzer according to [19], wherein the surface has a curvature that directs the fluorescence towards an optical axis of the at least one optic.

[23] The bioparticle analyzer according to [19], wherein the bioparticle analyzer is configured to perform flow cytometry and obtain measurements corresponding to the one or more biological particles.

[24] A microchip for microparticle analysis including:

at least one channel configured to provide a flow path for one or more microparticles; and

at least one optic configured to receive fluorescence generated by irradiating at least some of the one or more microparticles in the flow path with at least one light beam, the at least one optic having a surface configured to direct the fluorescence, wherein a first portion of the surface is configured to receive the at least one light beam, the first portion having a different curvature than at least one second portion of the surface.

[25] A microparticle analyzer including:

a microchip for microparticle analysis including:

at least one channel configured to provide a flow path for one or more microparticles; and

at least one optic configured to receive fluorescence generated by irradiating at least some of the one or more microparticles in the flow path with at least one light beam, the at least one optic having a surface configured to direct the fluorescence, wherein a first portion of the surface is configured to receive the at least one light beam, the first portion having a different curvature than at least one second portion of the surface; at least one light source configured to generate the at least one light beam; and at least one detector configured to detect the fluorescence.

The following configurations are also within the technical scope of the present application.

[1] A microchip for bioparticle analysis including:

a flow path in which a biological particle flows; and

at least one fluorescence condensing portion through which at least one fluorescence generated by irradiation of at least one laser light beam on the biological particle in the flow path passes and that collects the fluorescence.

[2] The microchip for bioparticle analysis according to [1], in which the at least one fluorescence condensing portion includes a flat surface on a fluorescence emission surface, and the at least one laser light beam enters the flat surface.

[3] The microchip for bioparticle analysis according to [2], in which the flat surface is parallel to one surface of the microchip for bioparticle analysis.

[4] The microchip for bioparticle analysis according to [2] or [3], in which the flat surface is perpendicular to an optical axis of the laser light beam that enters the microchip for bioparticle analysis.

[5] The microchip for bioparticle analysis according to any one of [1] to [4], in which the microchip for bioparticle analysis is configured so that the at least one laser light beam passes through the at least one fluorescence condensing portion and reaches the biological particle in the flow path.

[6] The microchip for bioparticle analysis according to any one of [1] to [5], in which the microchip for bioparticle analysis is configured so that a plurality of laser light beams passes through the at least one fluorescence condensing portion and reaches the biological particle in the flow path.

[7] The microchip for bioparticle analysis according to any one of [1] to [6], in which the microchip for bioparticle analysis is configured so that the plurality of laser light beams passes through the at least one fluorescence condensing portion and reaches the biological particle in the flow path, and

at least two irradiation positions of the plurality of laser light beams are aligned along a direction in which the biological particle flows.

[8] The microchip for bioparticle analysis according to any one of [1] to [7], in which the number of the fluorescence condensing portions included in the microchip for bioparticle analysis is one,

the fluorescence condensing portion includes a flat surface on a fluorescence emission surface, and

the microchip for bioparticle analysis is disposed so that a plurality of laser light beams enters the flat surface.

[9] The microchip for bioparticle analysis according to any one of [1] to [7], in which the number of the fluorescence condensing portions included in the microchip for bioparticle analysis is plural,

each of the plurality of fluorescence condensing portions includes a flat surface on a fluorescence emission surface, and

the microchip for bioparticle analysis is disposed so that a single laser light beam enters the flat surface of each fluorescence condensing portion.

[10] The microchip for bioparticle analysis according to any one of [1] to [9], in which the fluorescence emission surface of each of the at least one fluorescence condensing portion is a convex surface.

[11] The microchip for bioparticle analysis according to [10], in which at least a part of the convex surface is a convex-lens-shaped curved surface.

[12] The microchip for bioparticle analysis according to [11], in which the convex-lens-shaped curved surface has a curvature that makes the at least one fluorescence be refracted to a side of an optical axis of the at least one laser light beam.

[13] The microchip for bioparticle analysis according to any one of [10] to [12], in which a flat surface is provided on a top of the convex surface.

[14] The microchip for bioparticle analysis according to any one of [10] to [13], in which

the flat surface is provided on the top of the convex surface, and

the flat surface is surrounded by a convex-lens-shaped curved surface.

[15] The microchip for bioparticle analysis according to any one of [1] to [14], in which

the flat surface is provided on the fluorescence emission surface of each of the at least one fluorescence condensing portion, and

an area of the flat surface is equal to or more than an area of a spot region of a laser light beam that enters the flat surface on the flat surface.

[16] A bioparticle analyzer including:

a microchip for bioparticle analysis including a flow path in which a biological particle flows and at least one fluorescence condensing portion through which at least one fluorescence generated by irradiation of at least one laser light beam on the biological particle in the flow path passes and that collects the fluorescence;

a laser light beam irradiation device configured to irradiate the laser light beam toward the biological particle in the flow path; and

a fluorescence detection device configured to detect the fluorescence.

[17] The bioparticle analyzer according to [16], in which the microchip for bioparticle analysis is removable from the bioparticle analyzer.

[18] A microchip for fine particle analysis including:

a flow path in which a fine particle flows; and

at least one fluorescence condensing portion through which at least one fluorescence generated by irradiation of at least one laser light beam on the fine particle in the flow path passes and that collects the fluorescence.

[19] A fine particle analyzer including:

a microchip for fine particle analysis including a flow path in which a fine particle flows and at least one fluorescence condensing portion through which at least one fluorescence generated by irradiation of at least one laser light beam on the fine particle in the flow path passes and that collects the fluorescence;

a laser light beam irradiation device configured to irradiate the laser light beam toward the fine particle in the flow path; and

a fluorescence detection device configured to detect the fluorescence.

### REFERENCE SIGNS LIST

10 Microchip for bioparticle analysis

13 Flow path

14 Biological particle

15 Fluorescence condensing portion

16 Fluorescence emission surface

1. microchip for bioparticle analysis comprising:
at least one channel configured to provide a flow path for one or more biological particles; and
at least one optic configured to receive fluorescence generated by irradiating at least some of the one or more biological particles in the flow path with at least one light beam, the at least one optic having a surface configured to direct the fluorescence, wherein a first portion of the surface is configured to receive the at least one light beam, the first portion having a different curvature than at least one second portion of the surface.

2. The microchip for bioparticle analysis according to claim 1, wherein the first portion of the surface has a smaller curvature than the at least one second portion of the surface.

3. The microchip for bioparticle analysis according to claim 1, wherein the first portion of the surface is substantially flat.

4. The microchip for bioparticle analysis according to claim 1, wherein the first portion of the surface is substantially parallel to a surface of the microchip.

5. The microchip for bioparticle analysis according to claim 1, wherein the first portion of the surface is inclined with respect to a surface of the microchip.

6. The microchip for bioparticle analysis according to claim 1, wherein the first portion of the surface is substantially perpendicular to the at least one light beam.

7. The microchip for bioparticle analysis according to claim 1, wherein the at least one optic is positioned relative to the at least one channel such that the at least one optic is configured to direct at least a portion of the at least one light beam to the flow path.

8. The microchip for bioparticle analysis according to claim 1, wherein the at least one light beam includes a plurality of light beams, and the at least one optic is positioned relative to the at least one channel such that the at least one optic is configured to direct at least a portion of the plurality of light beams to the flow path.

9. The microchip for bioparticle analysis according to claim 8, wherein at least two irradiation positions of the plurality of light beams are aligned along a flow direction of the flow path.

10. The microchip for bioparticle analysis according to claim 1, wherein the first portion is positioned to receive a plurality of light beams.

11. The microchip for bioparticle analysis according to claim 1, wherein the at least one optic includes a plurality of optics, each having a substantially flat portion of a surface, and the microchip is positioned such that the substantially flat portion of the surface for one or more of the plurality of optics is configured to receive at least some of the at least one light beam.

12. The microchip for bioparticle analysis according to claim 1, wherein the surface is at least partially curved.

13. The microchip for bioparticle analysis according to claim 12, wherein at least a part of the surface has a convex shape.

14. The microchip for bioparticle analysis according to claim 13, wherein the surface has a curvature that directs the fluorescence towards an optical axis of the at least one optic.

15. The microchip for bioparticle analysis according to claim 13, wherein the first portion is at a location corresponding to a peak in curvature of the convex shape.

16. The microchip for bioparticle analysis according to claim 12, wherein the surface has a second portion having a convex shape, the second portion surrounding the first portion.

17. The microchip for bioparticle analysis according to claim 1, wherein the first portion has an area equal to or greater than a cross-sectional area of the at least one light beam.

18. The microchip for bioparticle analysis according to claim 1, wherein the at least one optic is integrated with the microchip.

19. A bioparticle analyzer comprising:
a microchip for bioparticle analysis including:
at least one channel configured to provide a flow path for one or more biological particles; and
at least one optic configured to receive fluorescence generated by irradiating at least some of the one or more biological particles in the flow path with at least one light beam, the at least one optic having a surface configured to direct the fluorescence, wherein a first portion of the surface is configured to receive the at least one light beam, the first portion having a different curvature than at least one second portion of the surface;
at least one light source configured to generate the at least one light beam; and
at least one detector configured to detect the fluorescence.

20. The bioparticle analyzer according to claim 19, further comprising an apparatus having the at least one light source and the at least one detector, and wherein the microchip is configured to detachably couple to the apparatus.

21. The bioparticle analyzer according to claim 19, wherein the first portion of the surface is substantially parallel to a surface of the microchip.

22. The bioparticle analyzer according to claim 19, wherein the surface has a curvature that directs the fluorescence towards an optical axis of the at least one optic.

23. The bioparticle analyzer according to claim 19, wherein the bioparticle analyzer is configured to perform flow cytometry and obtain measurements corresponding to the one or more biological particles.

24. A microchip for microparticle analysis comprising:
at least one channel configured to provide a flow path for one or more microparticles; and
at least one optic configured to receive fluorescence generated by irradiating at least some of the one or more microparticles in the flow path with at least one light beam, the at least one optic having a surface configured to direct the fluorescence, wherein a first portion of the surface is configured to receive the at least one light beam, the first portion having a different curvature than at least one second portion of the surface.

25. A microparticle analyzer comprising:
a microchip for microparticle analysis including:
at least one channel configured to provide a flow path for one or more microparticles; and
at least one optic configured to receive fluorescence generated by irradiating at least some of the one or more microparticles in the flow path with at least one light beam, the at least one optic having a surface configured to direct the fluorescence, wherein a first portion of the surface is configured to receive the at least one light beam, the first portion having a different curvature than at least one second portion of the surface;
at least one light source configured to generate the at least one light beam; and
at least one detector configured to detect the fluorescence.
